(19) United States
(12) Patent Application Publication
(10) Pub. No.: US 2014/0228505 A1
(43) Pub. Date: Aug. 14, 2014

(54) Elastomeric Compositions Comprising Reclaimed Elastomer Material

(71) Applicant: Lehigh Technologies, Inc., Tucker, GA (US)

(72) Inventor: Frank Papp, Fort Mill, SC (US)

(21) Appl. No.: 14/177,896

(22) Filed: Feb. 11, 2014

Related U.S. Application Data
(60) Provisional application No. 61/763,205, filed on Feb. 11, 2013.

(51) Int. Cl. C08L 19/00

(52) U.S. Cl. CPC C08L 19/003
USPC 524/526; 525/237

(57) ABSTRACT

Curable elastomer compositions are described which include particles of reclaimed elastomeric material having a particle size of 60 mesh or smaller, sulfur and one or more accelerators, wherein the ratio by weight of the one or more accelerators to sulfur in the composition is at least 1:1. Curable styrene butadiene rubber (SBR) elastomer compositions are also described which include reclaimed elastomeric material, sulfur and one or more accelerators, wherein the ratio by weight of the one or more accelerators to sulfur in the composition is at least 1:1. The cured elastomeric compositions exhibit improved physical properties compared to elastomer compositions containing reclaim material which employ conventional high sulfur cure systems.

### CROSS REFERENCE TO RELATED APPLICATIONS

This application claims the benefit of Provisional U.S. Application Ser. No. 61/763,205, filed Feb. 11, 2013, which is incorporated by reference herein in its entirety.

### BACKGROUND

1. Field

This application relates generally to curable elastomeric material compositions comprising reclaimed elastomer particles and, in particular, to such compositions having accelerator/sulfur ratios of 1:1 by weight or greater.

2. Background of the Technology

Reclaimed elastomer materials (i.e., “reclaimed materials,” “crumb rubber,” “ground tire rubber,” “GTR,” “micronized rubber powders,” or “MRP”), which include vulcanized elastomer materials, are used in a variety of applications, including elastomer compositions (e.g., tire tread compounds for vehicle tires), plastics compositions (e.g., as fillers for polyolefins), asphalt fillers, and others. Ground tire rubber (GTR) and Micronized Rubber Powder (MRP) differ primarily in particle size. GTR typically includes chips of reclaim material that are 1 inch or smaller and mostly 40 mesh (400 micron) and larger particles. In contrast, Micronized Rubber Powder (MRP) contains particles of reclaim material that are 40 mesh (400 micron) or smaller. In many of the applications for reclaim material, the reclaim material is used as “filler” in place of a portion of the virgin compound material. One of the primary reasons for the use of reclaimed elastomer materials is cost. Namely, rubber powders, for example MRP, are typically significantly less expensive than virgin (i.e., non-reclaimed) rubber or plastic, and when used as a “filler” in elastomer or plastic compositions, tends to reduce the overall manufacturing cost of the composition. Further, because micronized rubber powders typically are made from recycled or reclaimed material (e.g., vulcanized scrap from manufacturing processes and used tires or other elastomeric products), reincorporating them into elastomer and plastic compositions reduces landfill waste and results in a more environmentally-friendly product. Finally, use of recycled MRP provides a strategic supply chain hedge against petroleum-based supply chain price and supply volatility.

While elastomer compositions comprising MRP exhibit improved mechanical properties as compared to elastomer compositions comprising GTR, the use of MRP in admixture with virgin material can still result in a reduction in the mechanical properties of the resulting elastomer formulations. It was assumed previously that elastomer compositions comprising MRP would exhibit comparable performance characteristics irrespective of the cure system used. Specifically, the conventional assumption has been that elastomer compositions and other material compositions comprising MRP would exhibit diminished physical properties (e.g., measured through tensile strength, rebound, and dynamic heat build-up and compression set tests from a Flexometer machine) as compared to those comprising functionalized MRP or virgin elastomer materials.

Therefore, there is a long-felt but unresolved need for elastomer compositions that comprise MRP, but which retain mechanical properties and simplified processing comparable to or better than elastomer compositions containing no reclaimed material. There is a further need for a method of producing elastomer compositions that comprise MRP via cure systems that enhance the properties, or at least maintain comparable properties, of the resulting composition as compared to those compositions including only native elastomer materials.

### SUMMARY

A curable elastomer composition is provided which comprises:

uncured elastomeric material;

particles of reclaimed elastomeric material having a particle size of 60 mesh or smaller;

sulfur; and

one or more accelerators;

wherein the ratio by weight of the one or more accelerators to sulfur in the composition is at least 1:1.

A curable elastomer composition is also provided which comprises:

uncured elastomeric material, wherein the uncured elastomeric material comprises styrene butadiene rubber (SBR);

reclaimed elastomeric material;

sulfur; and

one or more accelerators;

wherein the ratio by weight of the one or more accelerators to sulfur in the composition is at least 1:1.

According to some embodiments, the ratio by weight of the one or more accelerators to sulfur in the composition is at least 2:1 or at least 5:1.

According to some embodiments, the reclaimed elastomeric material is a micronized rubber powder (MRP) (e.g., cryogenically ground micronized rubber powder) having a particle size of 80 mesh or smaller or 120 mesh or smaller. The reclaimed elastomeric material may include functionalized particles of reclaimed elastomeric material.

According to some embodiments, the reclaimed elastomeric material comprises devulcanized reclaimed elastomeric material (e.g., chemically devulcanized reclaimed elastomeric material).

According to some embodiments, the uncured elastomeric material comprises an elastomer selected from the group consisting of natural rubber (NR), styrene butadiene rubber (SBR), emulsion styrene butadiene rubber (E-SBR), polybutadiene (BR) and combinations thereof

According to some embodiments, the one or more accelerators are selected from the group consisting of diphenyl guanidine (DPG), N-tert-butyl-2-benzothiazyl sulfenamide (TBBS) and combinations thereof. According to some embodiments, the one or more accelerators comprise diphenyl guanidine (DPG) and N-tert-butyl-2-benzothiazyl sulfenamide (TBBS).

According to some embodiments, the composition comprises at least 5% by weight of the reclaimed elastomeric material or wherein the composition comprises at least 10% by weight of the reclaimed elastomeric material.

A cross-linked elastomer composition as set forth above and an article of manufacture comprising the cross-linked elastomer composition are also described. The article of manufacture can be a tire comprising a tread and sidewalls wherein the cross-linked elastomer composition forms a portion of the tread and/or the sidewalls of the tire.

These and other features of the present teachings are set forth herein.

### DESCRIPTION OF THE VARIOUS EMBODIMENTS

As set forth above, reclaimed elastomer materials in particulate form are commonly used as a “filler” to replace of a portion of the virgin elastomer material. The cured or vulcanized particles, however, are relatively inert and generally non-reactive with virgin matrix materials. As such, they are limited in their use as a component in elastomer compositions because, when added at high levels, the resultant elastomer composition exhibits diminished performance characteristics. This limitation, however, can be eased by the use of functionalized particles.

Vulcanized elastomer material can be functionalized through a variety of processes. Broadly speaking, functionalization involves modifying the chemistry of the vulcanized particles. One such functionalization process is devulcanization, processes for which are disclosed, for example, in U.S. Pat. No. 5,770,632 and U.S. Patent Application Publication No. 2010/0317752. Generally speaking, devulcanization involves the chemical, thermal, and/or mechanical treatment of vulcanized elastomer to break the chemical crosslinks formed during the vulcanization process. One devulcanization process involves applying a chemical additive to the reclaimed vulcanized particles while the particles are under shear stresses. This type of functionalization is performed, for example, by Levgum, Ltd., having a principal place of business in Kanot, Israel. An alternate devulcanization process utilizes high temperatures as opposed to chemicals to break the chemical crosslinks. In these processes, the input powder is reacted and generally converted into a spongy mass. The resulting devulcanized (i.e., functionalized) material can then be used in admixtures with virgin elastomeric materials.

Vulcanization is a chemical process for converting, or curing, rubber polymers into more durable materials via the addition of sulfur or other equivalent “curatives” and chemicals that modify the vulcanization process. Together, these additives modify the polymer by forming molecular crosslinks (bridges) between individual polymer chains. The combination sulfur and additives that affect the vulcanization process is also know as the “cure system” or “cure package”. There are a number of vulcanization systems used in crosslinked elastomers. A conventional cure system for diene type rubbers is generally a high sulfur and a low accelerator content. Sulfur to accelerator ratios can be as high as 5:1, 6:1, or higher, to as low as 2:1 depending on the rubber application.

A semi-EV cure system is defined as one having approximately an equal phr loading of sulfur and accelerators, generally a 1:1 ratio. An EV cure system is defined as having a low sulfur and a high accelerator content. Sulfur to accelerator ratios can be from 1:2 to 1:6 or 1:7, approximately the inverse of the conventional cure.

The boundary line between each of the three systems is not well defined and is generally determined by the crosslink types that are generated.

The term EV stands for “efficient vulcanization,” which means how efficiently the cure system uses the sulfur. Cure systems which provide di-sulfidic (two sulfur atoms, S2), and poly-sulfidic (more than 2 sulfur atoms, S>2) per crosslink are generally not using the sulfur as efficiently as systems that generate mono-sulfidic crosslinks (one sulfur atom, S1) per linkage.

The use of a conventional cure system tends to provide different crosslink types based on the polymer system. In natural rubber (NR), the conventional cure system provides almost all di-sulfidic (S2) and poly-sulfidic (S>2) crosslink types, and no mono-sulfidic crosslinks (S1); while in butadiene rubber (BR) and styrene-butadiene rubber (SBR) polymers, approximately 62% S2 and S>2 crosslinks are generated and 38% S1 crosslinks are made.

Using an EV cure system in NR provides approximately 54% S2 and S>2 crosslinks and 46% S1 crosslinks, and in BR and SBR polymers approximately 14% S2 and S>2 crosslinks are generated and 86% S1 crosslinks are made. Using a semi-EV cure system will provide crosslink types generally midway between the conventional and EV systems. A rubber chemist has to decide the best cure system to use depending on many decision criteria discussed below.

From a raw material cost stand point, the conventional cure system is usually the lowest cost because elemental sulfur is significantly cheaper than accelerators, anywhere from 10 times to 30 times cheaper depending on the accelerator used. However, if a high sulfur to accelerator system is used, typically oil treated sulfur or oil treated high heat stability sulfur is used which can be essentially the same cost as the lowest cost accelerators.

From a rubber factory processing view, mixing an EV system may be a challenge for properly dispersing the high loadings of accelerators, as is the mixing of high loadings of sulfur. Both high loading of sulfur in a conventional cure and a high loading of accelerators in an EV system may present challenges for sulfur or accelerator “bloom” on the uncured rubber surface. Bloom means that excess chemicals migrate to the rubber surface. Processing mixed rubber with an EV system may have shorter working times due to faster scorch. Rheometer tests on mixed rubber with an EV cure system will show the faster scorch times and a faster cure rate.

Comparing cured rubber for basic physical properties, one with a conventional cure and another with an EV cure system, as long as the crosslink densities are the same, the rubber with the EV system will tend to be slightly higher in modulus and lower in elongation at break. Tensile strength in the EV system may be higher if the crosslink density is not too high. This is because tensile strength typically peaks at a certain crosslink density but will decline with continued increases in crosslink density.

A rubber chemist's expectation is that certain modulus dependent test results will improve with the EV cure system due to more restrictive polymer chain mobility from the shorter crosslinks. These tests may include hysteresis, heat build-up, compression set, and potentially abrasion resistance. The tests that are expected to show lower performance are those that are extensibility dependent, such as elongation to failure, fatigue to failure, and crack growth resistance. Low temperature properties such as snow, ice, wet and dry traction for tire treads may also be diminished. Rubber cured with di- and poly-sulfidic crosslinks also have the ability to break and reform during cyclic deformation such as in a fatigue test, providing the energy dissipation for higher fatigue life. Rubber cured with EV cure systems with high mono-sulfidic linkages do not display the ability to break and reform during cyclic deformation.

Most rubber chemists know that the bond strengths of mono-sulfidic crosslinks are higher than those of the di- and poly-sulfidic types, so the expectation is the rubber cured with EV cure systems will have higher resistance to heat aging degradation and the ability to retain more of its original properties after aging. It is expected that rubber cured with the semi-EV cure systems will display properties in between those of the conventional and the EV system.

While elastomer compositions comprising MRP exhibit improved mechanical properties as compared to elastomer compositions comprising GTR, the use of MRP in admixture with virgin material can still result in a reduction in the mechanical properties of the resulting elastomer formulations. It was assumed previously that elastomer compositions comprising MRP would exhibit comparable performance characteristics irrespective of the cure system used. Specifically, the conventional assumption has been that elastomer compositions and other material compositions comprising MRP would exhibit diminished physical properties (e.g., measured through tensile strength, rebound, and dynamic heat build-up and compression set tests from a Flexometer machine) as compared to those comprising functionalized MRP or virgin elastomer materials.

For the purpose of promoting an understanding of the principles of the present disclosure, reference will now be made to the embodiments illustrated in the tables, and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates.

As used herein and recited in the Tables that follow, the term “PolyDyne” or “PD” refers to a brand name of vulcanized elastomer particles (e.g., cured rubber particles, recycled rubber particles, ground tire rubber, GTR, micronized rubber powder, or MRP) produced by Lehigh Technologies, Inc. of Tucker, Ga. According to one embodiment, the particles described herein are produced via a cryogenic grinding system described by U.S. Pat. No. 7,445,170, entitled Process and Apparatus for Manufacturing Crumb and Powder Rubber, and an impact mill as described by U.S. Pat. No. 7,861,958, entitled Conical-Shaped Impact Mill. In other embodiments of the present disclosure, these micronized rubber powders are produced via a variety of other known processes and techniques as will occur to one of ordinary skill in the art, and the powders used herein are not limited to the specific cryogenic grinding processes described herein.

As also used herein, “PD80” generally refers to a reclaimed elastomer material composition (i.e., micronized rubber powder) conforming to conventional 80 mesh standards, “PD140” generally refers to a reclaimed elastomer material composition (i.e., micronized rubber powder) conforming to conventional 140 mesh standards, etc. Thus, PD140, PD80, etc. are proprietary brand names used to describe specific reclaimed elastomer material compositions (in these cases, MRP) produced by Lehigh Technologies, Inc., which have predetermined particle size distributions. As will be understood and appreciated, the specific formulations associated with PD140 or PD80 or any other formulation are presented purely for illustrative purposes and elastomeric compositions, reclaimed elastomer material compositions, or other elastomer formulations contemplated by the present disclosure are not limited to the specific characteristics or features recited herein.

Further, as used herein, “functionalized” material generally refers to functionalized or devulcanized material made from micronized rubber powders, as described herein above. In one embodiment, this functionalized material is obtained from Levgum, Ltd., which as noted previously, has a principal place of business in Kanot, Israel. For the particular experiments described herein, Levgum, Ltd. used PD80 MRP manufactured by Lehigh Technologies, Inc., as the vulcanized particulate feedstock. This material will be referred to herein as LG80. As will be understood and appreciated, the functionalized material obtained from Levgum, Ltd., is simply one type of functionalized material that can be utilized within embodiments of the present formulations or compositions, and aspects of the present disclosure are not intended to be limited in any way to use of a specific functionalized or devulcanized material.

As noted previously, it heretofore was assumed that elastomer compositions comprising functionalized or non-functionalized MRP would exhibit diminished performance characteristics as compared to similar compositions including no MRP, irrespective of the cure system used. Put differently, it was assumed that elastomer compositions comprising functionalized material made from standard (or conventional), semi-EV, or EV cure systems would exhibit similar mechanical properties as compared to each other, and that the properties would be diminished as compared to compositions comprising no MRP. In other words, the effect of the MRP would dominate the properties of the compound compared to the effect of the cure system. To confirm this assumption and to identify and collect statistical measures relating to strength and other durability characteristics of such elastomer compositions, sample elastomer formulations comprising various types of MRP (functionalized and standard material) were produced using different cure systems such that their performance characteristics could be tested and compared to each other and to control samples comprising no MRP.

The mesh size of the reclaim material as used herein refers to an average particle size designation and can be determined in compliance with applicable standards, including ASTM D5644-01 (2008). For example, the Ro-tap method (Method A of the ASTM standard) is based on a size designation screen which allows a range for the upper limit retained of a maximum 5% by weight for up to 850 μm (20 mesh) particles, a maximum of 10% by weight for 600 to 150 μm (30 to 100 mesh) particles, and a maximum of 15% by weight for 128 to 75 μm (120 to 200 mesh) particles. According to this method, no particles are retained on the zero screen. Method B of the ASTM standard is an ultrasonic technique which involves counting the number of particles at a particular size.

Included in this document are Tables I, II, III, IV, and V, which help to explain the present subject matter and set forth experimental results relating to the same.

Specifically, Table IA comprises exemplary formulations of elastomer compositions comprising various functionalized material as well as compositions comprising functionalized material of differing particle size input. Included in Table I is the estimated material cost, calculated using known published list prices of each of the ingredients. The exemplary control formulations that are shown in Table I, Control and Control-EV, include no MRP (either vulcanized or functionalized). The compounds have the sulfur content adjusted in order to provide test compounds that have a very close modulus match to the control compound. These sulfur adjustments are well known [1, 2, 3, 4]. Modulus matching is very important in comparisons of various rubber compounds, as valid comparisons of other properties cannot be made if the compounds are significant differences in modulus. In addition, modulus is a critical parameter in tire design because of its direct impact on tire performance.

TABLE IA
Compositions

| | | | | | | 10% | | |
|---|---|---|---|---|---|---|---|---|
| | | Control | 10% | 10% | 10% | PD140 | 10% | 10% |
| | Control | EV | PD80 | PD80 EV | PD140 | EV | LG80 | LG80 EV |
| | Units | | | | | | | |
| | PHR | PHR | PHR | PHR | PHR | PHR | PHR | PHR |
| ESBR1500 (Non-oil extended) | 40.00 | 40.00 | 40.00 | 40.00 | 40.00 | 40.00 | 40.00 | 40.00 |
| Carbomix SBR BMB 1847K | 67.50 | 67.50 | 67.50 | 67.50 | 67.50 | 67.50 | 67.50 | 67.50 |
| High Cis PBR (CB 1220) | 30.00 | 30.00 | 30.00 | 30.00 | 30.00 | 30.00 | 30.00 | 30.00 |
| PD140 | | | | | 22.73 | 22.94 | | |
| LG80 | | | | | | | 22.71 | 22.94 |
| PD80 | | | 22.73 | 22.94 | | | | |
| Nytex 4700 Process Oil | 5.00 | 5.00 | 5.00 | 5.00 | 5.00 | 5.00 | 5.00 | 5.00 |
| Struktol 40MS | 1.00 | 1.00 | 1.00 | 1.00 | 1.00 | 1.00 | 1.00 | 1.00 |
| Alkyl Phenol Formaldehyde Novalak Tack Resin | 3.00 | 3.00 | 3.00 | 3.00 | 3.00 | 3.00 | 3.00 | 3.00 |
| N339 Carbon Black | 42.50 | 42.50 | 42.50 | 42.50 | 42.50 | 42.50 | 42.50 | 42.50 |
| 6PPD Antidegradant (PD-2) | 2.00 | 2.00 | 2.24 | 2.26 | 2.24 | 2.26 | 2.23 | 2.26 |
| Antioxidant DQ (TMQ) | 1.00 | 1.00 | 1.12 | 1.13 | 1.12 | 1.13 | 1.12 | 1.13 |
| Akrowax 5084 (Wax Blend) | 2.00 | 2.00 | 2.24 | 2.26 | 2.24 | 2.26 | 2.23 | 2.26 |
| Zinc Oxide Dispersion (85% ZnO) | 3.53 | 3.53 | 3.53 | 3.53 | 3.53 | 3.53 | 3.53 | 3.53 |
| Stearic Acid | 2.00 | 2.00 | 2.00 | 2.00 | 2.00 | 2.00 | 2.00 | 2.00 |
| TBBS | 1.00 | 5.25 | 0.85 | 5.25 | 0.85 | 5.25 | 0.85 | 5.25 |
| DPG | 0.10 | | 0.10 | | 0.10 | | 0.10 | |
| Sulfur Dispersion (80% Sulfur) | 2.75 | 0.94 | 3.44 | 0.94 | 3.44 | 0.94 | 3.16 | 0.94 |
| Retarder CTP | 0.10 | 0.20 | 0.10 | 0.20 | 0.10 | 0.20 | 0.10 | 0.20 |
| Total PHR Finish Batch | 203.48 | 205.92 | 227.34 | 229.51 | 227.34 | 229.51 | 227.03 | 229.51 |
| Estimated US$/kg | 3.070 | 3.078 | 2.859 | 2.869 | 2.903 | 2.913 | 2.904 | 2.913 |

The amount of sulfur (phr) for each of the compositions is shown below in Table 1B.

TABLE IB
Amount of Sulfur (phr) in Each Composition

| | | | | | | 10% | | |
|---|---|---|---|---|---|---|---|---|
| | | Control | 10% | 10% | 10% | PD140 | 10% | 10% |
| | Control | EV | PD80 | PD80 EV | PD140 | EV | LG80 | LG80 EV |
| Sulfur | 2.20 | 2.20 | 2.75 | 0.75 | 2.75 | 0.75 | 2.53 | 0.75 |
| Sulfur Dispersion | 2.75 | 2.75 | 3.44 | 0.94 | 3.44 | 0.94 | 3.16 | 0.94 |
| (80% Sulfur) | | | | | | | | |

Table 1C provides additional information regarding the formulations, including the estimated relative cost per kg, the relative volume cost (relative cost/volume), the total weight percent sulfur and the weight percent of accelerators in each composition.

TABLE IC
Additional Data for Compositions

| | | | | | | 10% | | |
|---|---|---|---|---|---|---|---|---|
| | | Control | 10% | 10% | 10% | PD140 | 10% | 10% |
| | Control | EV | PD80 | PD80 EV | PD140 | EV | LG80 | LG80 EV |
| 2011 US$/l Volume Cost | 3.486 | 3.491 | 3.249 | 3.254 | 3.299 | 3.304 | 3.299 | 3.304 |
| Density kg/l | 1.135 | 1.134 | 1.137 | 1.134 | 1.137 | 1.134 | 1.136 | 1.134 |
| Total PHR Polymer | 100.00 | 100.00 | 100.00 | 100.00 | 100.00 | 100.00 | 100.00 | 100.00 |
| Natural Rubber Wgt % | 0.0% | 0.0% | 0.0% | 0.0% | 0.0% | 0.0% | 0.0% | 0.0% |
| Synthetic Rubber Wgt % | 49.1% | 48.6% | 44.0% | 43.6% | 44.0% | 43.6% | 44.0% | 43.6% |
| Total Wgt % Polymer | 49.1% | 48.6% | 44.0% | 43.6% | 44.0% | 43.6% | 44.0% | 43.6% |
| Carbon black Wgt % N339 | 31.9% | 31.6% | 28.6% | 28.3% | 28.6% | 28.3% | 28.6% | 28.3% |
| Fabric, fillers, chemicals, etc. Wgt % | 18.9% | 19.9% | 27.4% | 28.1% | 27.4% | 28.1% | 27.3% | 28.1% |
| Total Wgt % | 100.0% | 100.0% | 100.0% | 100.0% | 100.0% | 100.0% | 100.0% | 100.0% |
| Total PHR Polymer | 100.00 | 100.00 | 100.00 | 100.00 | 100.00 | 100.00 | 100.00 | 100.00 |
| Total Wgt % Polymer | 49.1% | 48.6% | 44.0% | 43.6% | 44.0% | 43.6% | 44.0% | 43.6% |
| Total PHR Carbon Black | 65.00 | 65.00 | 65.00 | 65.00 | 65.00 | 65.00 | 65.00 | 65.00 |
| Total PHR Oil | 20.00 | 20.00 | 20.00 | 20.00 | 20.00 | 20.00 | 20.00 | 20.00 |
| Wgt % Oil | 9.83% | 9.71% | 8.80% | 8.71% | 8.80% | 8.71% | 8.81% | 8.71% |
| Wgt % Accelerators | 0.54% | 2.55% | 0.42% | 2.29% | 0.42% | 2.29% | 0.42% | 2.29% |
| Total Wgt % Sulfur | 1.08% | 0.36% | 1.21% | 0.33% | 1.21% | 0.33% | 1.11% | 0.33% |
| Wgt % MRP | 0.00% | 0.00% | 10.00% | 10.00% | 10.00% | 10.00% | 10.00% | 10.00% |
| Wgt % Antidegradants | 2.46% | 2.43% | 2.46% | 2.46% | 2.46% | 2.46% | 2.46% | 2.46% |
| Wgt % 6PPD | 0.98% | 0.97% | 0.983% | 0.98% | 0.98% | 0.98% | 0.98% | 0.98% |
| Wgt % TMQ | 0.49% | 0.49% | 0.493% | 0.49% | 0.49% | 0.49% | 0.49% | 0.49% |
| Wgt % Wax | 0.98% | 0.97% | 0.983% | 0.98% | 0.98% | 0.98% | 0.98% | 0.98% |
| Wgt % PD80 | 0.00% | 0.00% | 10.00% | 10.00% | 0.00% | 0.00% | 0.00% | 0.00% |
| Wgt % PD140 | 0.00% | 0.00% | 0.00% | 0.00% | 10.00% | 10.00% | 0.00% | 0.00% |
| Wgt % Levgum80 | 0.00% | 0.00% | 0.00% | 0.00% | 0.00% | 0.00% | 10.00% | 10.00% |
| Est. Relative Cost/kg | 100.0 | 100.3 | 93.1 | 93.4 | 94.5 | 94.9 | 94.6 | 94.9 |
| Relative Volume Cost | 100.00 | 100.00 | 93.21 | 93.35 | 94.64 | 94.78 | 94.64 | 94.78 |

Table II includes experimental results relating to physical property testing of the cured elastomer composition samples (as described in Table I). Also included in Table II is the Estimated Relative Cost, indexed to the Control compound. Tests were performed, as detailed in Table II, to measure various physical properties of the samples. For instance, tensile strength data, as per test method ASTM D412 and measured in MPa, was collected for various samples. The Rebound Test was performed on a Zwick Rebound Tester per ASTM D7121. The Flexometer test for Heat Build Up and Compression Set was performed on a BF Goodrich Flexometer Model II per ASTM D623.

TABLE II
Physical Properties.

| | | | | | | 10% | | |
|---|---|---|---|---|---|---|---|---|
| | | Control | 10% | 10% | 10% | PD140 | 10% | 10% |
| | Control | EV | PD80 | PD80 EV | PD140 | EV | LG80 | LG80 EV |
| Est. Relative Cost/kg | 100.0 | 100.3 | 93.1 | 93.4 | 94.5 | 94.9 | 94.6 | 94.9 |
| Tensile Strength, Mpa (unaged) | 17.1 | 18.1 | 15.2 | 16.5 | 16.1 | 17.4 | 16.8 | 16.9 |
| Elongation, % (unaged) | 617.8 | 600.4 | 577.0 | 595.2 | 597.6 | 616.3 | 618.7 | 592.0 |
| 300% Modulus, Mpa (unaged) | 8.7 | 9.5 | 8.2 | 8.7 | 8.5 | 9.0 | 8.5 | 9.0 |
| Rebound @ 0 C., % | 28.7 | 29.3 | 27.0 | 28.0 | 27.0 | 27.5 | 27.0 | 27.8 |
| Rebound @ 70 C., % | 51.1 | 53.1 | 49.8 | 51.0 | 49.7 | 52.1 | 50.0 | 53.0 |
| Rebound 70 C./Relative Cost | 51.1 | 53.0 | 53.4 | 54.5 | 52.5 | 54.9 | 52.9 | 55.8 |
| Rebound Delta | 22.5 | 23.9 | 22.8 | 23.0 | 22.7 | 24.6 | 23.1 | 25.1 |
| Heat Build Up, C. | 34.4 | 27.8 | 40.7 | 31.3 | 39.9 | 30.1 | 40.2 | 28.4 |
| Compression Set, % | 8.5 | 3.4 | 12.8 | 5.5 | 12.6 | 4.5 | 12.0 | 4.1 |

In Table III, the aging response of the formulations shown in Table I is provided. Separate groups of samples were aged for 48 hours at 100° C. (48H @ 100° C.) or for 2 weeks at 70 degrees C. (2 W @ 70° C.).

TABLE III
Aging Response.

| | | | | 10% | | 10% | | 10% |
|---|---|---|---|---|---|---|---|---|
| | | Control | 10% | PD80 | 10% | PD140 | 10% | LG80 |
| | Control | EV | PD80 | EV | PD140 | EV | LG80 | EV |
| Tensile Strength, Mpa (unaged) | 17.1 | 18.1 | 15.2 | 16.5 | 16.1 | 17.4 | 16.8 | 16.9 |
| Elongation, % (unaged) | 617.8 | 600.4 | 577.0 | 595.2 | 597.6 | 616.3 | 618.7 | 592.0 |
| 300% Modulus, Mpa (unaged) | 8.7 | 9.5 | 8.2 | 8.7 | 8.5 | 9.0 | 8.5 | 9.0 |
| Tensile Strength, Mpa (48 Hr@100° C.) | 16.3 | 16.9 | 14.6 | 15.9 | 15.2 | 16.7 | 15.8 | 16.6 |
| % change in Tensile | −4.3% | −6.6% | −3.6% | −3.8% | −5.8% | −4.3% | −5.7% | −2.3% |
| Elongation, % (48 Hr@100° C.) | 406.8 | 499.0 | 344.1 | 508.1 | 357.2 | 534.3 | 375.1 | 522.5 |
| % change in Elongation | −34.1% | −16.9% | −40.4% | −14.6% | −40.2% | −13.3% | −39.4% | −11.7% |
| 300% Modulus, Mpa (48 Hr@100° C.) | 12.4 | 10.8 | 12.9 | 9.9 | 12.9 | 9.9 | 12.9 | 10.0 |
| % change in Modulus | 42.4% | 14.5% | 57.4% | 13.3% | 52.5% | 10.7% | 50.6% | 11.5% |
| Tensile Strength, Mpa (2 Wk@70° C.) | 16.9 | 17.5 | 15.4 | 15.9 | 16.6 | 17.0 | 16.8 | 16.5 |
| % change in Tensile | −0.9% | −3.7% | 1.3% | −3.7% | 3.0% | −23% | 0.0% | −2.6% |
| Elongation, % (2 Wk@70° C.) | 413.5 | 493.5 | 391.1 | 484.9 | 411.7 | 519.6 | 431.9 | 489.4 |
| % change in Elongation | −33.1% | −17.8% | −32.2% | −18.5% | −31.1% | −15.7% | −30.2% | −17.3% |
| 300% Modulus, Mpa (2 Wk@70° C.) | 12.7 | 11.2 | 12.0 | 10.3 | 12.4 | 10.3 | 11.9 | 10.5 |
| % change in Modulus | 45.4% | 18.7% | 46.8% | 18.0% | 46.4% | 15.4% | 39.8% | 16.6% |

In Table IV, example fatigue testing data is provided for three formulations. The fatigue testing was performed in Lehigh Technologies' Application and Development Center. The Fatigue to Failure test method is ASTM D 4482. The testing was performed using the #14 cam, which provides a 100% extension.

TABLE IV
Fatigue to Failure Testing

| | Control | 10% PD80 | 10% LG80 EV |
|---|---|---|---|
| 1 | 17,600 | 38,400 | 595,300 |
| 2 | 64,800 | 485,400 | 221,500 |
| 3 | 123,900 | 20,600 | 27,900 |
| 4 | 101,600 | 225,300 | 319,200 |
| 5 | 58,300 | 23,600 | 837,600 |
| 6 | 178,300 | 287,800 | 39,200 |
| 7 | 76,100 | 226,200 | 400,400 |
| 8 | 52,800 | 172,200 | 409,600 |
| 9 | 40,300 | 327,700 | 187,600 |
| 10 | 117,300 | 20,100 | 64,700 |
| 11 | 134,700 | 288,500 | 837,600 |
| 12 | 24,100 | 89,900 | 419,300 |
| Average | 82,483 | 183,808 | 363,325 |
| Median | 70,450 | 198,750 | 359,800 |
| Max | 178,300 | 485,400 | 837,600 |
| Min | 17,600 | 20,100 | 27,900 |
| Normalized | 100 | 282 | 511 |

In Table V, the cure rheology for the formulations shown in Table I is provided. The cure testing was performed on an Alpha Technologies Rheometer MDR-2000 per ASTM D5289.

TABLE V
Cure Rheology

| | | | | | | 10% | | |
|---|---|---|---|---|---|---|---|---|
| | | Control | 10% | 10% | 10% | PD140 | 10% | 10% |
| | Control | EV | PD80 | PD80 EV | PD140 | EV | LG80 | LG80 EV |
| Maximum Torque @ 160, dNm | 1.52 | 1.36 | 1.89 | 1.73 | 1.89 | 1.74 | 1.93 | 1.74 |
| Minimum Torque @ 160, dNm | 14.8 | 15.1 | 13.7 | 13.4 | 14.2 | 13.7 | 14.2 | 13.7 |
| Scorch Time Ts1, min | 4.8 | 4.6 | 4.0 | 3.6 | 4.1 | 4.0 | 3.7 | 3.7 |
| Time to 10% cure, Tc10, min | 5.1 | 5.1 | 4.2 | 3.8 | 4.3 | 4.2 | 3.9 | 3.9 |
| Time to 50% cure, Tc50, min | 7.9 | 8.0 | 7.1 | 5.8 | 7.3 | 6.3 | 6.4 | 5.7 |
| Time to 90% cure, Tc90, min | 13.0 | 12.8 | 12.5 | 9.5 | 12.8 | 10.2 | 11.0 | 9.5 |
| Cure Rate Index, CRI(90/1) | 12.1 | 12.1 | 11.7 | 17.0 | 11.5 | 16.3 | 13.8 | 17.2 |
| CRI % increase with EV | | 0% | | 45% | | 41% | | 25% |
| Min − Max Torque delta, dNm | 13.3 | 13.7 | 11.8 | 11.7 | 12.3 | 11.9 | 12.3 | 12.0 |

Referring to the Tensile Strength, Elongation, and Modulus results from Table II, there are at least four surprising results to be noted for the compounds that contain both MRP (whether functionalized or not) and an EV cure system (Hereafter referred to as MRP-EV compounds: 1) the tensile strength of compound PD140EV is improved relative to the control compound; 2) the elongation of compounds PD80EV and PD140EV is improved relative to PD80 and PD140, respectively; 3) the fact that PD80EV and PD140EV have improvement in both tensile strength and elongation compared to PD80 and PD140, respectively; and 4) the modulus of all three MRP-EV compounds is a better match to the control modulus than the modulus of the Control-EV compound. These results are surprising because EV compounds to not generally result in an increase in tensile strength and/or elongation. [5]

Referring to the 0 degrees C. Rebound results from Table II, the following results are surprising: that all MRP-EV compounds have a lower rebound than the Control, especially given that the Control-EV has a higher rebound than the Control. In general is desirable to have lower rebound at 0 degrees C. as an indicator for improved wet traction.

Referring to the 70 degrees C. rebound results from Table II, the following results are surprising: 1) all MRP-EV compounds have a rebound that is comparable to or higher than the control; 2) the LG80EV compound has a rebound that is comparable to the Control-EV compound. In general it is desirable to have higher rebound at 70 degrees C. as an indicator for lower hysteresis resulting in improved fuel economy

Referring to Table II, Rebound Delta is the difference between the 70 degree C. rebound and the 0 degree C. It is desirable to have a large Rebound Delta to give the best overall combination of fuel economy and wet traction. The following results are surprising: the Rebound Delta for both PD140EV and LG80EV is improved compared to the Rebound Delta for both Control and Control-EV compounds. In other words, PD140EV and LG80EV provide an improved combination of fuel economy and wet traction than either of the control compounds.

Referring to the Heat Build Up (HBU) data in Table II, it is known that the use of EV cure systems can provide an improvement in HBU. For example, it is shown in the table that Control-EV has an improvement of 6.6 degrees, or 19% relative to Control. What is surprising is that EV cure systems provide an even greater improvement in HBU when used in MRP systems. For PD80, the improvement is 9.4 degrees, or 23%. For PD140, the improvement is 9.8 degrees, or 25%. For LG80, the improvement is 11.8 degrees, or 29%. Additionally surprising is that the HBU temperatures for all three MRP-EV compounds are improved relative to the Control compound.

Referring to the Compression Set data in Table II, it is surprising that the compression set value for all three MRP-EV compounds show an improvement relative to the Control compound.

Referring to the improved results for Rebound, HBU, and Compression Set for MRP-EV compounds, the results are surprising because previous work on MRP compounds indicates that these properties are always diminished. [1]

The final surprising analysis from Table II is the overall cost-effectiveness of the three MRP-EV compounds: 1) Compounds PD140EV and LG80EV provide an overall improved balance of properties compared to Control compound, at a much lower cost; 2) Compounds PD140EV and LG80EV provide an overall equivalent balance of properties compared to Control-EV compound, at a much lower cost; 3) Compound PD80EV provides an overall comparable balance of properties compared to Control compound, at a much lower cost; and 4) all three MRP-EV compounds provide a significant improvement in overall balance of properties compared to the respective MRP compounds, at only a slight increase in cost.

Referring to Table III, the Aging Response, the surprising properties of MRP-EV compounds are again demonstrated. It is generally desirable in aging response to have a minimal change in properties, because this means that the properties of the rubber compound have minimal change over time and the performance of the compound is more consistent and predictable. It is the change in elongation and modulus that are the most important. This is because the elongation and modulus aging responses are generally increased compared to the tensile strength response. Furthermore, the elongation response is related to a change in the extensibility of the rubber and the modulus response is related to the stiffness of the tire rubber. Retaining high extensibility and minimizing the change in stiffness of a tire rubber are important qualities over the lifetime of a tire. It is also known that EV compounds have generally improved aging response, because of the relatively high amount of stable mono-sulfidic crosslinks compared to standard cure systems. This is demonstrated in Table III wherein the Control-EV has an improved aging response compared to Control with respect to the Elongation and Modulus properties.

It can be seen in Table III that the MRP compounds have an aging response generally worse than either the Control or Control-EV. It could be expected then, that the aging response of the MRP-EV compounds should be in-between the aging response of the Control-EV and MRP compounds. Surprisingly, this is not the case. The MRP-EV compounds have improved aging response as compared to the Control, the Control-EV, and the MRP compounds: The average aging response for Elongation and Modulus, for both aging cycles, for the three MRP-EV compounds is 14.7%, for the Control-EV compound 17.0%, for the Control compound 33%, and for the three MRP compounds 42.2%.

In Table IV the Fatigue to Failure for 12 samples each of three compounds is shown. The data for LG80EV is shown as being significantly improved relative to Control and PD80. This is unexpected, because EV compounds generally do not have improved fatigue life compared to standard cure systems. [5]

In Table V the cure rheology is shown. The improvement in MRP-EV systems can be seen by the increase in CRI, or cure rate index. The CRI is the average slope (Torque difference divided by time difference) of the cure rate cure curve from scorch (Ts1) to 90% cure (Tc90). The Control-EV compound shows no improvement compared to the control compound, while all of the MRP-EV compounds show significant improvement compared to both the respective MRP compounds, the Control compound, and the Control-EV compound.

While not wishing to be bound by theory, various mechanisms can be proposed to explain the significant improvements in properties and processing for MRP-EV compounds. It may be that the presence of vulcanized MRP particles during mixing provides for better dispersion of EV chemicals. Or, the relative high percentage of EV chemicals may provide for more covalent bond formation between the MRP particles and the rubber matrix. Regardless of the mechanism, the inventions taught herein provide for elastomer compositions and methods of manufacturing elastomer compositions with improved properties, improved economics, and/or improved sustainability.

Generally, the novel compositions and methods described herein relate to improved elastomer compositions that comprise a certain percentage of MRP and/or functionalized MRP. In particular, these compositions are generally produced using an EV cure system (as defined above). Use of an EV cure system to produce such elastomer compositions has produced surprising results when used with certain types and/or sizes of MRP. Thus, by employing certain cure methodologies, the resultant MRP compositions can be produced in a more cost-effective and environmentally-friendly manner, while retaining or exhibiting improved physical properties as compared to those compositions produced via conventional cure systems.

The foregoing description of the exemplary embodiments has been presented only for the purposes of illustration and description and is not intended to be exhaustive or to limit the inventions to the precise forms disclosed. Many modifications and variations are possible in light of the above teaching.

### REFERENCES

[1] Papp, F. P., “Optimizing the Use of Micronized Rubber Powder”, Proceedings of the 180th Technical Meeting of the Rubber Division of the American Chemical Society, Paper 83 (2011).
[2] R. A. Swor, L. W. Jensen, M. Budzol, Rubber Chem. Technol. 53, 1215 (1980).
[3] D. Gibala, G. R. Hamed, Rubber Chem. Technol., 67, 636 (1994).
[4] Z. I. Grebenkina, N. D. Zakharov, and E. G. Volkova, International Polymer Science and Technology 5, No. 11, 2 (1978).
[5] Ingatz-Hoover, and Gilbert, “Better thermal and thermal oxidative aging resistance” Rubber & Plastics News, 14-16, Oct. 16, 2006.

What is claimed is:

1. A curable elastomer composition comprising:
uncured elastomeric material;
particles of reclaimed elastomeric material having a particle size of 60 mesh or smaller;
sulfur; and
one or more accelerators;
wherein the ratio by weight of the one or more accelerators to sulfur in the composition is at least 1:1.

2. The curable elastomer composition of claim 1, wherein the ratio by weight of the one or more accelerators to sulfur in the composition is at least 2:1 or at least 5:1.

3. The curable elastomer composition of claim 1, wherein the reclaimed elastomeric material comprises micronized rubber powder (MRP).

4. The curable elastomer composition of claim 4, wherein the micronized rubber powder (MRP) is cryogenically ground micronized rubber powder (MRP).

5. The curable elastomer composition of claim 4, wherein the micronized rubber powder (MRP) has a particle size of 80 mesh or smaller or wherein the micronized rubber powder (MRP) has a particle size of 120 mesh or smaller.

6. The curable elastomer composition of claim 1, wherein the reclaimed elastomeric material comprises functionalized particles of reclaimed elastomeric material.

7. The curable elastomer composition of claim 1, wherein the uncured elastomeric material comprises an elastomer selected from the group consisting of natural rubber (NR), styrene butadiene rubber (SBR), emulsion styrene butadiene rubber (SBR), polybutadiene (BR) and combinations thereof.

8. The curable elastomer composition of claim 1, wherein the uncured elastomeric material comprises styrene butadiene rubber (SBR), emulsion styrene butadiene rubber (E-SBR) and polybutadiene (BR).

9. The curable elastomer composition of claim 1, wherein the one or more accelerators are selected from the group consisting of diphenyl guanidine (DPG), N-tert-butyl-2-benzothiazyl sulfenamide (TBBS) and combinations thereof.

10. The curable elastomer composition of claim 9, wherein the one or more accelerators comprise diphenyl guanidine (DPG) and N-tert-butyl-2-benzothiazyl sulfenamide (TBBS).

11. The curable elastomer composition of claim 1, wherein the sulfur comprises oil treated sulfur or oil treated high heat stability sulfur.

12. The curable elastomer composition of claim 1, wherein the composition comprises at least 5% by weight of the reclaimed elastomeric material or wherein the composition comprises at least 10% by weight of the reclaimed elastomeric material.

13. The curable elastomer composition of claim 1, wherein the composition further comprises carbon black.

14. A cross-linked elastomer composition made by curing a composition as set forth in claim 1.

15. An article of manufacture comprising the cross-linked elastomer composition of claim 14.

16. The article of manufacture of claim 15, wherein the article of manufacture is a tire comprising a tread and sidewalls and wherein the cross-linked elastomer composition forms a portion of the tread and/or the sidewalls of the tire.

17. A curable elastomer composition comprising:
uncured elastomeric material, wherein the uncured elastomeric material comprises styrene butadiene rubber (SBR);
reclaimed elastomeric material;
sulfur; and
one or more accelerators;
wherein the ratio by weight of the one or more accelerators to sulfur in the composition is at least 1:1.

18. The curable elastomer composition of claim 17, wherein the reclaimed elastomeric material comprises devulcanized reclaimed elastomeric material.

19. The curable elastomer composition of claim 17, wherein the reclaimed elastomeric material comprises chemically devulcanized reclaimed elastomeric material.

20. The curable elastomer composition of claim 17, wherein the ratio by weight of the one or more accelerators to sulfur in the composition is at least 2:1 or at least 5:1.
